(19) United States
(12) Patent Application Publication
(10) Pub. No.: US 2014/0209522 A1
(43) Pub. Date: Jul. 31, 2014

(54) MOBILE WELL WATER DESALINIZATION SYSTEM AND METHOD OF OPERATION

(71) Applicant: Joseph Peter Krieger, Edmond, OK (US)

(72) Inventor: Joseph Peter Krieger, Edmond, OK (US)

(21) Appl. No.: 13/793,238

(22) Filed: Mar. 11, 2013

Related U.S. Application Data
(60) Provisional application No. 61/757,563, filed on Jan. 28, 2013.

(51) Int. Cl. C02F 9/00

(52) U.S. Cl. CPC C02F 9/005
USPC 210/170.09; 62/238.6

(57) ABSTRACT

A system for processing fluids comprising a fluid reservoir configured to contain a liquid. A float valve coupled to the fluid reservoir and configured to operate a fill valve. A condensation chamber. A thermal barrier disposed between the condensation chamber and the fluid reservoir. A first heat exchanger disposed within the fluid reservoir. A condensation unit disposed in the condensation chamber. A compressor coupled to the condensation unit. A second heat exchanger disposed within the fluid reservoir and coupled to the compressor. An expansion valve coupled to the second heat exchanger and the condensation unit, the expansion valve configured to receive the compressed coolant from the second heat exchanger and to expand the compressed coolant into the condensation unit.

### RELATED APPLICATIONS

The present application claims benefit of U.S. Provisional Patent Application No. 61/757,563, filed Jan. 28, 2013, which is hereby incorporated by reference as if fully set forth herein for all purposes.

### TECHNICAL FIELD

The present disclosure relates generally to desalinization, and more specifically to a mobile well water desalinization system and method of operation that allows water for fracking and drilling to be recycled without significant infrastructure investment.

### BACKGROUND OF THE INVENTION

Modern drilling techniques require a significant amount of water for drilling and hydraulic fracturing (“fracking”) of the oil- or gas-bearing reservoir. If local water sources are unavailable, then the cost to ship in water for drilling and fracking can be significant.

### SUMMARY OF THE INVENTION

A system for processing fluids is provided that includes a fluid reservoir configured to contain a liquid, such as well water or other suitable water sources. A float valve coupled to the fluid reservoir operates a fill valve, such as to maintain the level of water in the fluid reservoir. A condensation chamber condenses steam generated by heating of the well water. A thermal barrier is disposed between the condensation chamber and the fluid reservoir to improve thermal efficiency. A heat exchanger disposed within the fluid reservoir is used to heat the well water. A condensation unit disposed in the condensation chamber is used to condense the steam from the heated well water. A compressor coupled to the condensation unit is used to pump heat from the condensation unit to the fluid reservoir. An expansion valve coupled to the second heat exchanger and the condensation unit receives the compressed coolant from the second heat exchanger and expands the compressed coolant into the condensation unit.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for desalinization of water in accordance with an exemplary embodiment of the present disclosure;

FIG. 2 is a diagram of a mobile platform in accordance with an exemplary embodiment of the present disclosure;

FIG. 3 is a diagram of a pond layout in accordance with an exemplary embodiment of the present disclosure; and

FIG. 4 is a diagram of a process for treating water in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

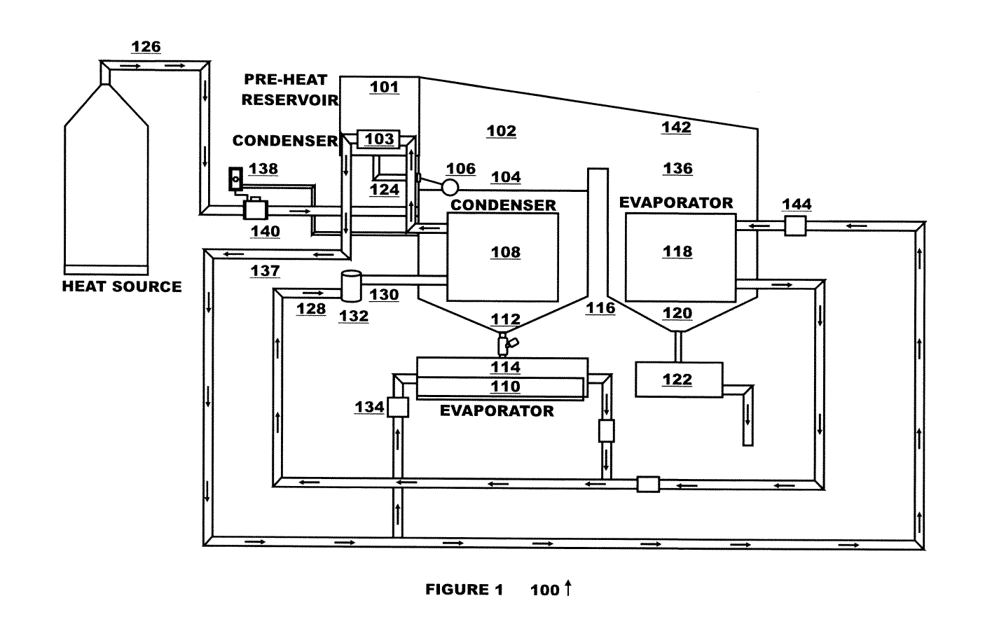

FIG. 1 is a diagram of a system 100 for desalinization of well water in accordance with an exemplary embodiment of the present disclosure. System 100 is configured for modular deployment, to increase the total heat transfer surface area for condensation of evaporate per unit volume, and also to allow system 100 to be deployed on a mobile platform, so as to be relocated where needed based on drilling and fracking operations.

System 100 removes dissolved solids (TDS) from a body of water. The dissolved solids can include salt, heavy metals, nitrates, nitrites, pharmaceuticals or other suitable dissolved solids. System 100 can be configured for stationary or mobile deployment, and can be used to increase the total heat transfer surface area for condensation of evaporate per unit volume.

Water is transferred into water reservoir 101 from a source. The water enters heating side 102 of the cell through a float switch 106 until the water reaches a level above the condenser 108. Heat source 126 raises the temperature of the treated or non-treated water to its boiling point. When the water reaches its boiling point, a signal from thermostat 138 causes steam valve 140 to be closed. Compressor 132 starts and pumps a coolant through the heating and cooling unit. As the coolant discharges from compressor 132 the coolant is at its maximum temperature and passes through condenser 108 and releases the heat from condenser 108 into body of water 104. The coolant discharges from condenser 108 and enters condenser 103 to release heat into the incoming water for pre-heating. The coolant flows from condenser 103 through conduit 137 and into expansion valve 144 to lower the temperature in the coolant and then into evaporator 118, which is separated from condenser 108 by an insulator 116. The steam flowing through expansion valve 144 is forced through evaporator 118. The heat from the steam transfers into the coolant changing the steam to water. The heated coolant discharges from evaporator 118 through conduit 128 and into compressor 132, completing the loop. The condensed water from evaporator 118 flows to conical bottom 120 before falling in discharge box 122. This water is virtually free of dissolved solids. As water 104 evaporates in heating reservoir 102, the salt or other dissolved solids become more concentrated forming crystals. The crystals settle into conical bottom 122. A pneumatic valve operated through a timer opens to release the crystals into the container 114. The coolant from conduit 137 flows through expansion valve 134 to cool the coolant before entering evaporator 110. The coolant from evaporator 110 discharges into conduit 128 and then to compressor 132. The cooled coolant in evaporator 110 removes the heat from the salt slurry. When the water 104 temperature lowers to 110 degrees, a signal from thermostat 138 cause steam valve 140 to open, allowing steam in reservoir 102 to raise the temperature of the water back to a boiling point. The top of modular cell 142 slopes toward the cold side of the cell to prevent condensed vapor from dripping into the hot side.

In operation, system 100 allows water, such as water that has been generated from drilling an oil or gas well or hydraulic fracturing of the well or other waste water, to be reclaimed, so as to remove dissolved salts or other compounds. System 100 is modular, so that it can be duplicated and used in parallel, in series, or a suitable combination of series and parallel configurations, to more effectively utilize the available space for water processing. System 100 can also be installed on a mobile platform so as to allow system 100 to be readily relocated as needed, based on drilling activity.

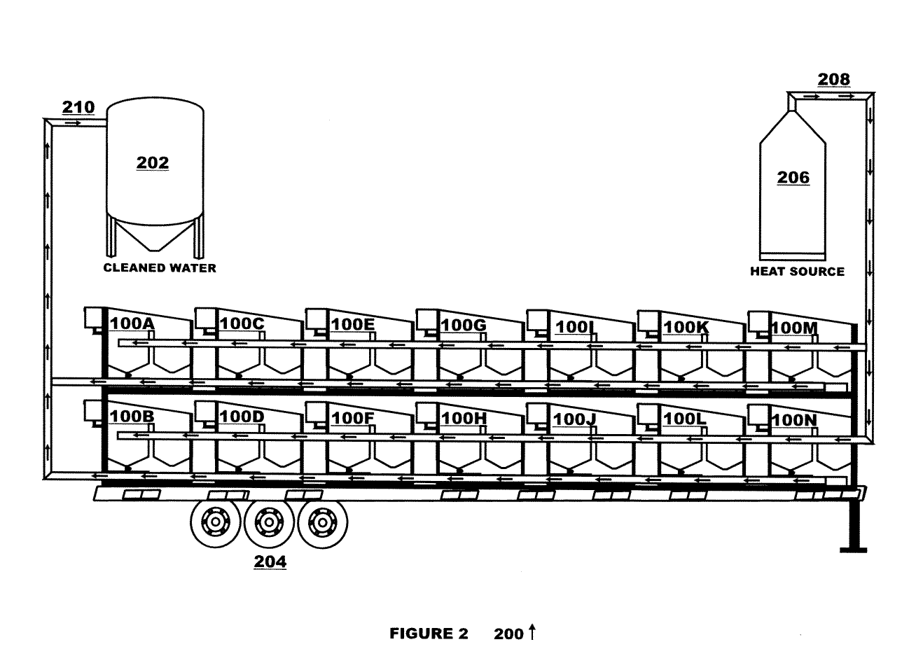

FIG. 2 is a diagram of a mobile platform 200 in accordance with an exemplary embodiment of the present disclosure. Mobile platform 200 includes modular desalinization units 100A through 100N, which are coupled to heat source 206 through pipe 208 and also to condensate line 210. Wheel 204 can be used to relocate mobile platform 200, based on drilling requirements. In one exemplary embodiment, mobile platform 200 can include pumps and associated transfer lines to allow treated water to be combined with desalinated water to generate water having suitable concentrations of dissolved solids for drilling, hydraulic fracturing or other operations. For example, if treated water has a concentration of dissolved solids of 15000 parts per million, and if water used for drilling must have no more than 5000 parts per million of dissolved solids, then desalinated water having a concentration of dissolved solids of 100 parts per million or less can be added to the treated water to dilute the concentration of dissolved solids from 15000 parts per million down to 5000 parts per million or less, such as by determining a concentration of dissolved solids in the treated water, by determining a concentration of dissolved solids in the desalinated water and then by combining the desalinated water with the treated water as it is generated by the desalinization units 100A through 100N of mobile platform 200, or in other suitable manners.

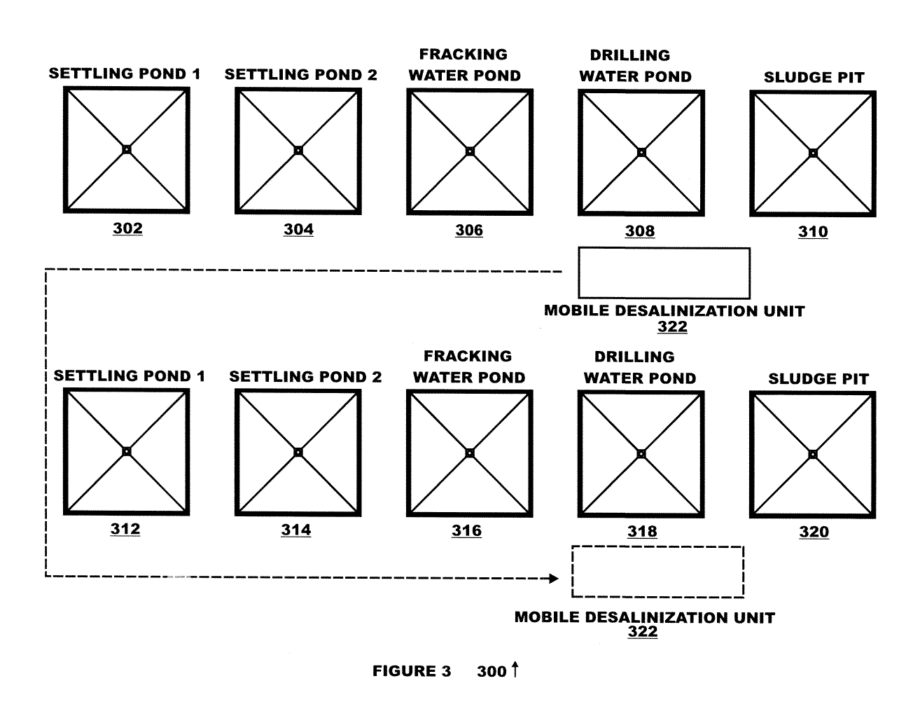

FIG. 3 is a diagram of a pond layout 300 in accordance with an exemplary embodiment of the present disclosure. Pond layout 300 includes settling pond 1 302, settling pond 2 304, fracking water pond 306, drilling water pond 308 and sludge pit 310, with mobile desalinization unit 322 located next to settling pond 2 304. During drilling operations, water is pumped to settling pond 1 302 until it is filled, after which it is pumped to settling pond 2 304 while the water in settling pond 1 302 is allowed to settle. In addition, coagulants, flocculants or other compounds can be added to the water, to facilitate settling of particulates and separation of oil. Likewise, the pH of the water can be adjusted to improve the settling of particulates, oxidation processing can be used, or other suitable treatment processing of the water can be performed. After particulates and oil have been separated from the water in settling pond 1 302, the water can also be filtered, such as by using diatomaceous earth, activated carbon or other suitable filter materials, to further remove particulates and oil from the water. The treated water is then tested to determine the level of the remaining amount of dissolved materials. For example, if the amount of dissolved materials is less than a first level, such as 5000 parts per million or other suitable levels, then the treated water can be transferred to drilling water pond 308. If the amount of dissolved materials is greater than the first level but less than a second level, then the treated water can be transferred to fracking water pond 306. If the amount of dissolved materials is greater than the second level, then mobile desalinization unit 322 can be used to generate distilled water having 100 parts per million or less of dissolved materials, which can then be mixed with the treated water in suitable amounts to create drilling water or fracking water, or which can be used for potable water supplies or other suitable purposes.

Once transfer or desalinization of the water in settling pond 1 302 and settling pond 2 304 has been completed, mobile desalinization unit 322 can be relocated as shown next to drilling water pond 318 or to other suitable locations, such as settling pond 1 312, settling pond 2 314, fracking water pond 316 and sludge pit 320, which can be located near other drilling operations that are adjacent to the drilling operations serviced by settling pond 1 302, settling pond 2 304, fracking water pond 306, drilling water pond 308 and sludge pit 310. In this manner, desalinization of water can be performed as needed and without the need to build permanent desalinization facilities.

The sludge remaining in settling pond 1 302 and settling pond 2 304 is transferred to sludge pit 310, in addition to any additional sludge generated during the desalinization process. Likewise, the sludge remaining in settling pond 1 312 and settling pond 2 314 is transferred to sludge pit 320, in addition to any additional sludge generated during the desalinization process. The sludge can also be periodically reclaimed for incineration, based on the energy content of the sludge, or for other suitable purposes. Settling pond 1 302, settling pond 2 304, settling pond 1 312 and settling pond 2 314 can be pre-formed conical pits, or can alternatively be tanks, polymer-lined earthen pits or other suitable structures.

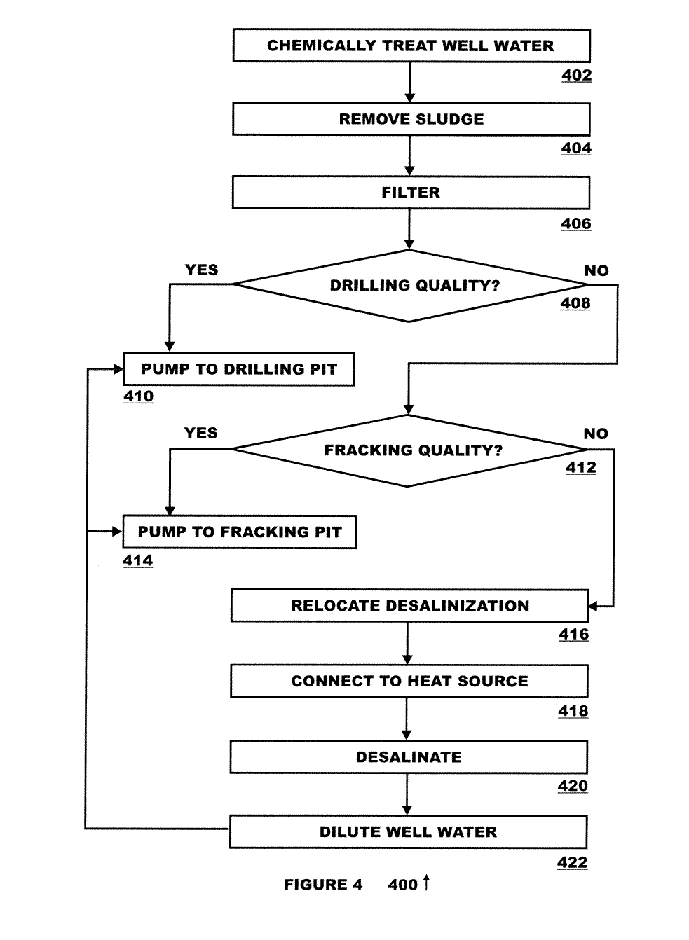

FIG. 4 is a diagram of a process 400 for treating water in accordance with an exemplary embodiment of the present disclosure. Process 400 begins at 402, where water is transferred to a settling pond or tank and is treated with coagulants, flocculants, acids or bases (to adjust the pH of the water to aid in coagulation), or other suitable materials to cause solids to settle out, to remove oil, or to remove other non-soluble contaminants. The process then proceeds to 404, where the resulting sludge is removed. Alternatively, the sludge can be removed after the treated water has been transferred. If a conical pit is used for the settling pond, the sludge can be pumped from a drain or valve at the bottom of the conical pit, or other suitable processes can be used. The process then proceeds to 406.

At 406, the treated water is filtered, such as with a diatomaceous earth filter, an activated carbon filter or by filtering with other suitable materials. The process then proceeds to 408, where it is determined whether the treated water can be used for drilling operations. In one exemplary embodiment, drilling can be performed with water that has no more than a first level of dissolved solids, such as 5000 parts per million or other suitable levels, as a function of drilling equipment materials, well type and other variables. If it is determined at 408 that the treated water can be used for drilling and that drilling water is needed, the process proceeds to 410, where the treated water is transferred to a drilling water tank, pond or other suitable storage structures. Likewise, if it is determined that the treated water is not suitable for use in drilling operations, the process proceeds to 412.

At 412, it is determined whether the treated water can be used for hydraulic fracturing operations. In one exemplary embodiment, hydraulic fracturing can be performed with water that has no more than a second level of dissolved solids, such as 4000 parts per million or other suitable levels, as a function of drilling equipment materials, well type and other variables. If it is determined at 412 that the treated water can be used for hydraulic fracturing and that hydraulic fracturing water is needed, the process proceeds to 414, where the treated water is transferred to a hydraulic fracturing water tank, pond or other suitable storage structures. Likewise, if it is determined that the treated water is not suitable for use in hydraulic fracturing operations, the process proceeds to 416.

At 416, a mobile desalinization unit is relocated to the location where the treated water is being held, such as a settling pond, a tank or other suitable locations. The process then proceeds to 418, where the mobile desalinization unit is connected to a suitable heat source. In one exemplary embodiment, a mobile heat and power source can be used, such as a gas or diesel fired generator. Likewise, a microwave heat source, a heater/generator that uses waste gases from drilling operations, or other suitable heat sources can also or alternatively be used. The process then proceeds to 420.

At 420, the treated water is desalinated, and the process proceeds to 422 where the desalinated water is mixed with the treated water to dilute the concentration of dissolved solids to below the first level if drilling water is needed, or to below the second level if hydraulic fracturing water is needed. Likewise, the desalinated water can be used for other suitable purposes, such as for agricultural uses or landscaping.

In operation, process 400 allows water to be locally treated and reused for drilling, hydraulic fracturing or other suitable purposes, through the use of a mobile desalinization unit and associated filtering and heat/power sources. Process 400 can use existing tanks, storage ponds or other facilities to first treat the water and to then dilute the treated water with desalinated water, if needed, to allow the treated water to be reused for drilling or hydraulic fracturing.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for processing fluids comprising:
a fluid reservoir configured to contain a liquid;
a float valve coupled to the fluid reservoir and configured to operate a fill valve if a fluid level of the liquid is lower than a predetermined level;
a condensation chamber;
a thermal barrier disposed between the condensation chamber and the fluid reservoir;
a first heat exchanger disposed within the fluid reservoir and configured to transfer heat to the liquid;
a condensation unit disposed in the condensation chamber and configured to receive a coolant and to exchange heat between the coolant and water vapor in the condensation chamber;
a compressor coupled to the condensation unit and configured to compress the coolant;
a second heat exchanger disposed within the fluid reservoir and coupled to the compressor, the second heat exchanger configured to receive the compressed coolant from the compressor and to exchange heat between the compressed coolant and the liquid; and
an expansion valve coupled to the second heat exchanger and the condensation unit, the expansion valve configured to receive the compressed coolant from the second heat exchanger and to expand the compressed coolant into the condensation unit.

2. The system of claim 1 further comprising a sump coupled to the water reservoir and configured to receive solid condensate from the water.

3. The system of claim 1 further comprising a sump coupled to the condensation chamber and configured to receive condensed water from the condensation unit.

4. The system of claim 1 wherein the fluid reservoir further comprises a protective coating.

5. The system of claim 1 wherein the first heat exchanger comprises tubing configured to carry a heated fluid.

6. The system of claim 1 further comprising a top disposed at angle over the fluid reservoir, thermal barrier and condensation chamber that prevents condensation from falling into the fluid reservoir.

7. The system of claim 1 wherein the condensation unit comprises a base and sloping sides that are inclined towards each other.

8. A system for processing fluids comprising:
a first settling pond configured to receive water from a drilling well and to allow solids to settle out of the water;
a second settling pond adjacent to the first settling pond and configured to receive water from a drilling well and to allow solids to settle out of the water;
a hydraulic fracturing water pond adjacent to the first settling pond and configured to hold water for use in hydraulic fracturing operations;
a drilling water pond adjacent to the hydraulic fracturing pond and configured to hold water for use in drilling operations;
a sludge pit adjacent to the drilling water pond and configured to receive sludge from the first settling pond and the second settling pond; and
a mobile desalinization unit configured to receive treated water from the first settling pond and the second settling pond, to desalinate the treated water and to combine the desalinated water with the treated water to generate drilling water.

9. The system of claim 8 wherein the mobile desalination unit is configured to combine the desalinated water with the treated water to generate hydraulic fracturing water.

10. The system of claim 8 wherein the mobile desalinization unit comprises a plurality of modular desalinization units operating on a mobile platform.

11. The system of claim 10 wherein the plurality of modular desalinization units are coupled to one or more common condensate lines.

12. The system of claim 10 wherein the plurality of modular desalinization units are coupled to a common heat source.

13. The system of claim 8 wherein the first settling pond comprises a preformed conical pit.

14. A method for processing fluids comprising:
transferring water from a well drilling operation to a first settling pond until a first level has been reached;
transferring the water from the drilling operation to a second settling pond while the water is settling in the first settling pond;
treating the water in the first settling pond to facilitate settling;
transferring the treated water from the first settling pond to a drilling water pond if a concentration of dissolved solids in the treated water is less than a first level;
transferring the treated water from the first settling pond to a hydraulic fracturing water pond if the concentration of dissolved solids in the treated water is greater than the first level and less than a second level; and
diluting the treated water with desalinated water if the concentration of dissolved solids in the treated water is greater than the second level.

15. The method of claim 14 further comprising:
relocating a mobile desalinization unit to an area adjacent to the first settling pond; and
desalinizing the treated water with the mobile desalinization unit.

16. The method of claim 15 further comprising:
treating the water in the second settling pond to facilitate settling;
transferring the treated water from the second settling pond to a drilling water pond after the treated water from the first settling pond has been depleted.

17. The method of claim 16 further comprising:
relocating a mobile desalinization unit to an area adjacent to the second settling pond; and
desalinizing the treated water from the with the mobile desalinization unit.
